(19) United States
(12) Patent Application Publication
(10) Pub. No.: US 2009/0157656 A1
(43) Pub. Date: Jun. 18, 2009

(54) AUTOMATIC, COMPUTER-BASED SIMILARITY CALCULATION SYSTEM FOR QUANTIFYING THE SIMILARITY OF TEXT EXPRESSIONS

(76) Inventors: Libo Chen, Weiterstadt (DE); Ulrich Thiel, Zwingenberg (DE); Peter Fankhauser, Darmstadt (DE); Thomas Kamps, Darmstadt (DE)

Correspondence Address: BARNES & THORNBURG LLP, 11 SOUTH MERIDIAN, INDIANAPOLIS, IN, 46204, US

(21) Appl. No.: 12/091,578

(22) PCT Filed: Oct. 26, 2006
(86) PCT No.: PCT/EP06/10332

§ 371 Date: Jul. 8, 2008

(30) Foreign Application Priority Data
Oct. 27, 2005 (DE) 10-2005-051-617.3

(51) Int. Cl. G06F 7/06; G06F 17/10; G06N 5/02; G06F 17/30

(52) U.S. Cl. 707/5; 708/212; 706/52; 707/E17.014; 707/E17.044

(57) ABSTRACT

A device and a method for automatic, computer-based similarity weighting of text expressions. The system and method contemplate a document data bank unit, a candidate expression memory unit and a similarity weight value calculation unit. The similarity weight values agw(t₁, t₂) can be calculated for the individual pairs of expressions on the basis of a similarity measure occ_con(t₁, t₂) which takes into account both the total frequency of the common occurrence of the two expressions of one pair of expressions within one text segment in a quantity of several text segments, and the total number of different context expressions in the quantity of text segments.

The present invention relates to an automatic, computer-based similarity calculation system and a corresponding similarity calculation method with which text expressions (subsequently simplified: expressions), which stem from one or several text documents which are stored in digital form, are examible in pairs with respect to their semantic similarity.

The present invention can hence be used in the field of automatic, computer-based structuring of information, in particular in the field of automatic, computer-based thesaurus construction and/or ontology construction.

In the following, firstly a few definitions of terms for the terms used subsequently are introduced. Further term definitions, if necessary, are introduced at the corresponding points in the subsequent description.

There should therefore be understood firstly by the term of expression (used synonymously thereto: term or concept) or text expression, a sequence of individual characters which comprises in total one word or several words (one-word expression or multiword expression from text). A word is hereby a character sequence which is delimited on both sides by blanks or punctuation symbols. A similarity can be determined for a pair or two such expressions. There is understood here by similarity a given semantic relationship (semantics: meaning of a natural language text). Such a similarity between two terms or expressions can be quantified by statistical methods (calculation of the similarity between two expressions). There is understood hence subsequently by similarity also a statistical dimension figure which describes the semantic relationship and is termed subsequently also as similarity weight value. The value termed subsequently as similarity weight value is also termed similarity measure in the literature. Synonymous with the term of similarity, the term of relation or the (associative) relationship between expressions is used.

There is understood subsequently by thesaurus a quantity of expressions or terms including a quantity of relations or similarities between these expressions. Thesauri which are produced manually and automatically hereby exist. Production of an automatic thesaurus is possible in that, in large document collections or collections (collection: quantity of individual text documents), above-described relations or associative relationships are derived from the common occurrence of words in individual text documents or in individual sections, sentences or parts of sentences within the documents. Those text parts or sections which are examined for the occurrence of individual terms are termed subsequently also as text segments. Such a text segment can therefore involve for example the entire text document, a section from the document or also a word window which comprises a defined number of successive individual words. Such a thesaurus can also be regarded as a (simple) description of an ontology, i.e. a structured knowledge base.

The process of automatic thesaurus construction can be divided into three phases:
1. Construction of the vocabulary or selection of the expressions.
2. Calculation of the statistical similarity between pairs of expressions of the selected vocabulary.
3. Organisation or structuring of the vocabulary (clustering).

The present invention hereby relates to point 2, i.e. the calculation of the statistical similarity between pairs of terms.

It is sensible in particular for the selection of vocabulary but also for assessment of the occurrence or non-occurrence of an expression within a text segment to subject the individual text documents of the collection to pre-processing (normalisation): the normalisation of the expressions hereby essentially comprises two parts, stop word elimination and basic form reduction. By means of stop word elimination, essentially the following expressions are removed from the text documents: adjectives and adverbs, prepositions and articles, numbers and very common words (for example “and” or “or”). If necessary, also proper names can be removed. In the case of a reduction to the root of a word, individual expressions or words are reduced to their roots. As a result, derivations (formations of new words from an original word) and inflexions (declension or conjugation of a word) are combined under the root. Subsequently, the term of root reduction is used synonymously with the term of basic form reduction, i.e. the removal of inflexion endings (a reduction of different derivations is hence not undertaken or considered).

The statistical similarity determination between respectively two expressions or pairs of expressions is a main point in the automatic production of thesauri. Corresponding approaches therefore already exist in prior art. A first group of approaches, subsequently also termed occurrence-based approaches (English occurrence), is hereby based on the frequency of occurrence of expressions in text segments. These approaches which are hence based on the common occurrence of two expressions of one pair of expressions in a text segment however leave the actual content of the context, in which the pair of expressions occur, unconsidered. The term of context, i.e. of the text surrounding a linguistic unit or an expression (hence i.e. the context of sense in which the expression occurs), is subsequently used synonymously with the term of text segment (i.e. a defined section of text in which the occurrence or appearance of an expression or a pair of expressions is examined).

Therefore more recent approaches attempt to consider jointly the actual content of the context in which an expression is located. There is understood subsequently by content (content) or content surroundings of an expression, the quantity or number of those expressions which occur together with a specific expression within one text segment or a quantity of text segments. Of disadvantage in the approaches of prior art based on content is the fact that these cannot differentiate between significant or essential and irrelevant or non-essential content. In the subsequent description, these mentioned disadvantages of prior art are dealt with in more detail.

The above-described disadvantages of prior art lead to the fact that up to now the statistical similarity relationship determination for pairs of expressions, i.e. the calculation of corresponding similarity weight values, is resolved merely in an unsatisfactory manner: hence in a not insignificant number of cases, to one pair of expressions between which a semantic similarity exists, a low similarity weight value is nevertheless allocated wrongly and vice versa to pairs of expressions between which merely a very remote or absolutely no semantic similarity exists, a too high similarity weight value is allocated wrongly.

It is therefore the object of the present invention to make available a device and a method with which the calculation of similarity weight values for pairs of expressions can be implemented in an improved manner, and with which the similarity weight values determined statistically for pairs of expressions hence reflect better the actual similarity of the meaning of two expressions of one pair of expressions.

This object is achieved by a similarity calculation system according to claim 1 and also a similarity calculation method according to claim 31. Advantageous embodiments of the similarity calculation system according to the invention and of the corresponding calculation method are described in the respective dependent claims.

The object according to the invention is achieved in that an improved similarity measure occ_con(t₁, t₂) for the similarity of two expressions t₁ and t₂ (pair of expressions (t₁, t₂)) is provided, which takes into account both the common occurrence of the two expressions within text segments and the number of different context expressions in the text segments (context expressions are expressions which occur in at least one text segment together with t₁ and in at least one further text segment together with t₂ but correspond or are equal to neither t₁ nor t₂). The similarity measure occ_con according to the invention which combines the occurrence- and content context (occ stands for occurrence, con for content) is then used for the purpose of calculating similarity weight values agw(t₁, t₂) for pairs of expressions.

As is described subsequently in more detail, the similarity measure according to the invention can be used for similarity weightings known from prior art, such as for example the cosine similarity weighting or the PMI similarity weighting. An essential aspect of the invention however is in addition also making available according to the invention new similarity weightings or similarity weight values calculated with the help of the similarity measure according to the invention, in particular the weighting rel_comb which is described subsequently in more detail and is based on the product of several individual weightings. This is represented in more detail in the subsequent description of the embodiments.

The similarity measure according to the invention and the similarity weight values according to the invention or the similarity calculation system/-method according to the invention has significant advantages relative to the state of the art: thus experiments show that the best of the similarity weight values according to the invention calculated with the help of the similarity measure according to the invention, in comparison with document-based occurrence approaches of prior art, has a result which is improved by 70% with respect to the F measure.

An automatic, computer-based similarity calculation system or a corresponding similarity calculation method can be carried out or used as described in detail in the subsequent example.

There are shown:

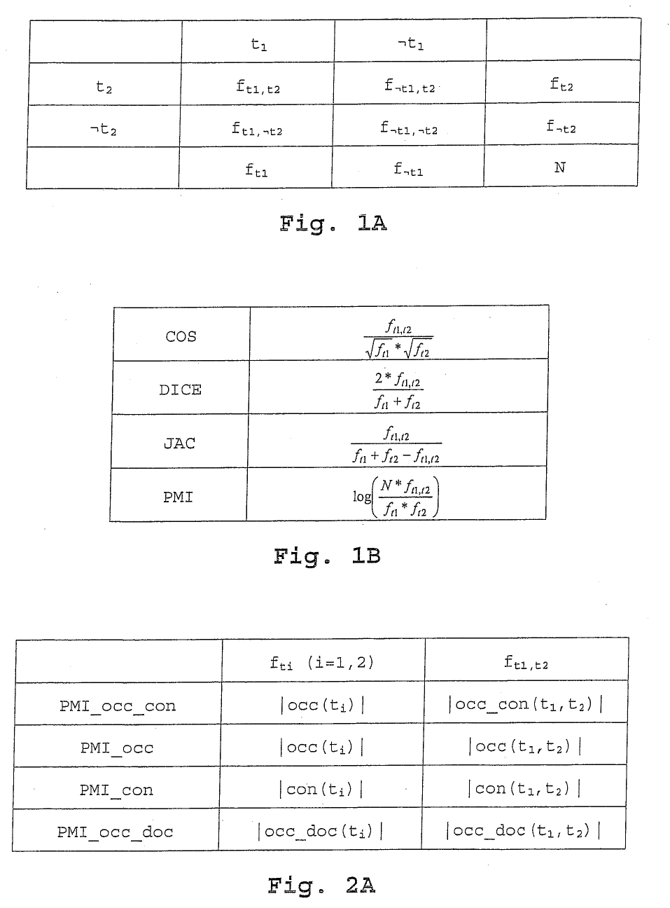

FIG. 1 several already known similarity weightings which can be calculated likewise using the similarity measure according to the invention.

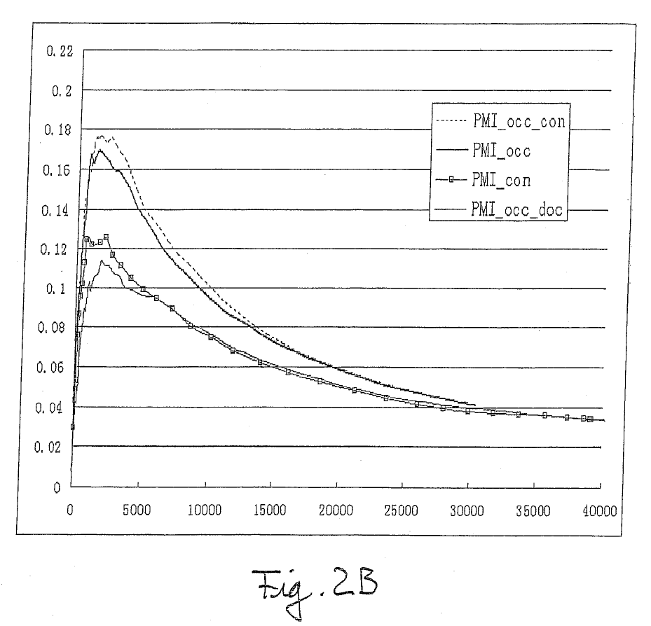

FIG. 2 the already known similarity weighting PMI, as can be calculated conventionally and with the similarity measure according to the invention, as a comparison.

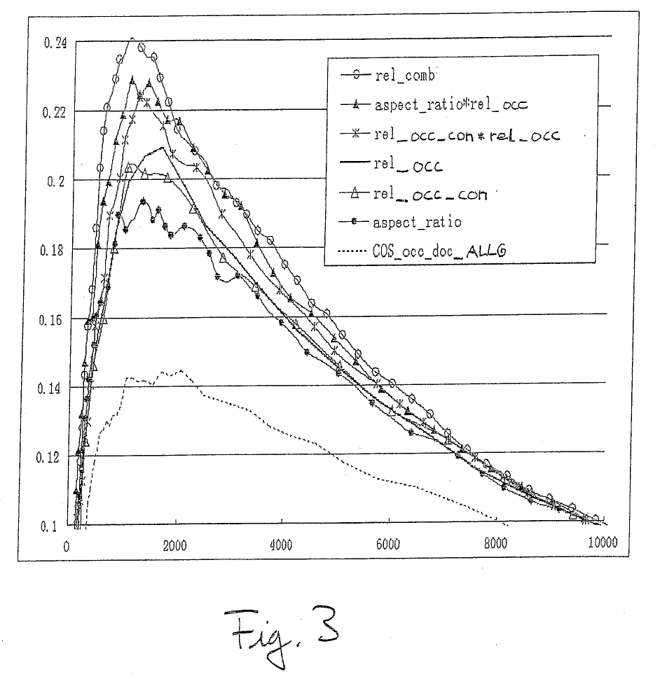

FIG. 3 a comparison of several similarity weightings according to the invention which were calculated on the basis of the similarity measure according to the invention in comparison with each other and in comparison with similarity weightings calculated without the similarity measure according to the invention.

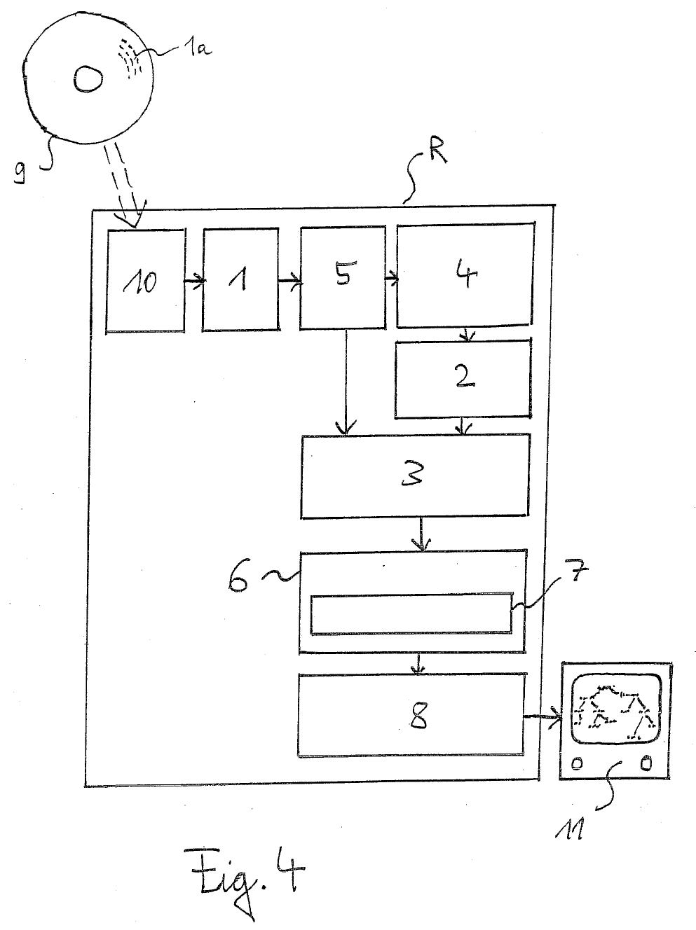

FIG. 4 shows schematically the construction of a similarity calculation system according to the invention.

The subsequent description of the embodiment is divided roughly into two sections. Firstly, the basic approaches from prior art and the similarity weightings already known from prior art and also the disadvantages associated therewith are represented. In the subsequent second section, it is described how the similarity measure occ_con(t₁, t₂) according to the invention is calculated and how the similarity weight values or weightings agw(t₁, t₂) according to the invention are calculated.

Determination of the similarities or relationships between expressions which is based on the statistical analysis of text collections is important for many applications, in particular in the field of automatic thesaurus construction or in the field of information retrieval (IR). All these approaches are based on a specific term (or on a specific idea) of a common context of expressions which is quantified by means of a similarity weight value which compares the individual context of expressions with their common context (i.e. their occurrence alone with their common occurrence within a text segment). A high similarity weight value shows the existence of a semantic relationship between two expressions t₁, t₂ of one pair of expressions (t₁, t₂). All the known similarity weight values can be used advantageously only for specific tasks, whilst they are not suitable or not very suitable for other tasks. The present invention relates in particular to the derivation of a similarity measure which is optimised with respect to the automatic thesaurus production and the calculation therefrom of similarity weight values which are optimised for this task.

It is hereby assumed essentially that the expressions which are essential for a given text collection are already identified; the invention hence is occupied in particular with the optimised determination of similarity weight values for pairs of expressions from this prescribed quantity of expressions (subsequently also termed quantity of candidate expressions tᵢ). The compilation of the quantity of candidate expressions can hereby be effected by means of a candidate expression selection unit which is based for example on the basis of selection algorithms which are represented in the subsequently mentioned publication: L. Chen, U. Thiel, M. L'Abbate, “Automatic Thesaurus Production and Query Expansion in an E-commerce Application”, Proceedings 8^{th} International Symposium for Information Technology, 2002, pp. 181-199 (subsequently: Reference 1).

Subsequently, firstly an overview of similarity weightings according to the state of the art is now provided. Following thereon is the discussion of the two essential terms of the common context known from the state of the art. Following hereon is a description of these two already known terms of the common context in the formalism of the related probabilities; the latter serves in particular for the purpose of preparing the derivation of the advantageous similarity weight values agw(t₁, t₂) according to the invention on the basis of the similarity measure occ_con(t₁, t₂) according to the invention. The latter derivation is represented in detail in the subsequent section which is concerned firstly with the introduction of a new term according to the invention of the common context which leads directly to the similarity measure according to the invention in order then to describe the subsequent similarity weightings according to the invention, in particular in the form of combined similarity weightings. Following thereon finally is a section which reveals the advantages of the combined similarity weightings according to the invention in comparison with the similarity weightings of the state of the art. The latter takes place by comparison of the automatically determined relationships or similarity weightings with a gold standard thesaurus.

### Statistical Similarity Quantification According to the State of the Art

### a) Similarity Weightings

Semantic similarity relationships between two expressions or terms are usually based on common properties of the terms. The statistical quantification of the similarity relationships uses this principle, in that the context, i.e. the surrounding text of an expression or the connection in which the expression occurs within a text collection or within a body of text, is regarded as property. The context of a (single) expression can be defined as the quantity of all text segments (or the number thereof) in which the expression occurs individually. The common context of two expressions can then be defined as the quantity of all text segments (or the number thereof) in which the two expressions occur together (i.e. within one and the same text segment). The previously mentioned two definitions relate to those approaches of the state of the art which operate on the basis of occurrence or implement an analysis of the common occurrence of terms. The content of the individual text segments is hereby not taken into account. In contrast hereto, the content-based approaches of the state of the art, as described already, use the content (i.e. the other expressions within the text segments) which occur around the expressions to be examined within the text segments. In the case of the latter approaches, the common context is provided by the intersection (or by the corresponding number of expressions within this intersection) of expressions which (relative to a quantity of text segments to be examined) occur both at least once together with the first expression t₁ of the pair of expressions (t₁, t₂) within one text segment and occur at least once with the second expression t₂ of the pair of expressions together in one text segment. Subsequently, the first definition of the context is termed occurrence context and the second definition of the context content context.

Several similarity weightings for quantifying the similarity of pairs of expressions are known from the state of the art, i.e. for example the cosine coefficient COS, the so-called “dice” coefficient DICE (L. R. Dice “Measures of the Amount of Ecologic Association between Species”, J. of Ecology, 26, pp. 297-302), the JACCARD coefficient JAC (see for example Van Rijsbergen “Information Retrieval”, 2^{nd} Edition, 1979) or the pointwise common information (pointwise mutual information) PMI (see K. Church et al.: “Word Association Norms, Mutual Information and Lexicography”, Computational Linguistics, 16.1, 22-29, 1990). All these similarity weight values for pairs of expressions (t₁, t₂) can be represented formally via four possible combinations, which is shown normally in a contingency table, as is shown in FIG. 1A. tᵢ and [symbol] tᵢ hereby describe the presence or non-presence of the expression tᵢ (i=1, 2) in one context. f_{t1, t2} describes the frequency of those contexts or text segments in which both expressions t₁, t₂ occur together. [symbol] and [symbol] describe the frequency of contexts or text segments in which one of the two expressions but not the other occurs. Finally, [symbol] describes the frequency of the contexts or text segments in which none of the two expressions occurs. N indicates the number of text segments which are included in total in the consideration (N=fₜ₁+ [symbol] =f_{t2,}+ [symbol] ). If for example full sentences are chosen as text segments and the considered document collection contains 10⁵ different sentences, then the value fₜ₁=10 for the term t₁=“cat” means that the term “cat” occurs in ten text segments or sentences of the 10⁵ sentences. [symbol] is then 9990. Together with t₂=“dog”, with fₜ₂=20, f_{t1, t2}=3 then means for example that t₁ and t₂ of the pair of expressions (t₁, t₂)=(“cat”, “dog”) occur together in three of these 10⁵ sentences within the respective sentence.

FIG. 1B now shows how the COS-, DICE-, JAC- and PMI coefficients are calculated from these frequencies. Of course, the frequency f_{t1, t2} which describes the common occurrence of the two expressions within one and the same text segment, produces the most important component of the represented similarity weightings.

The first three of the similarity weightings shown in FIG. 1B (i.e. COS, DICE, JAC) can be also generalised with respect to the used frequencies f in that these frequencies describe not only the pure number of text segments within which an expression occurs but rather for each text segment also the frequency with which an expression occurs within the text segment. Thus for example the COS coefficient can be generalised as follows:

$$COS\_ALLG ( {t}_{1} , {t}_{2} ) = \frac{{\sum }_{c ( t 1 , t 2 )} ( {f}_{c ( t 1 , t 2 ) , t 1} * {f}_{c ( t 1 , t 2 ) , t 2} )}{\sqrt{{\sum }_{c ( t 1 )} {( {f}_{c ( t 1 ) , t 1} )}^{2}} * \sqrt{{\sum }_{c ( t 2 )} {( {f}_{c ( t 2 ) , t 2} )}^{2}}}$$

tᵢ hereby means t₁ or t₂. In the case of the occurrence context, f_{c(t1, t2), ti} describes the frequency of the term tᵢ in a common text segment c of t₁ and t₂, i.e. in c(t1, t2) (a common text segment of t₁ and t₂ is a text segment in which both t₁ and t₂ occur) and f_{c(ti), ti} the frequency of the term tᵢ in a text segment c of tᵢ, i.e. in c(ti) (a text segment c of tᵢ is a text segment in which tᵢ occurs).

In the case of the content context, c(t1, t2) describes an expression c which occurs with t₁ in at least one text segment and occurs also with t₂ in at least one (further) text segment. f_{c(t1, t2), ti} describes the total frequency of the expression c(t1, t2) in all common text segments of c(t1, t2) and tᵢ. c(ti) describes an expression c which occurs together with tᵢ in at least one text segment. f_{c(ti), ti} describes the total frequency of the expression c(ti) in all common text segments of c(ti) and tᵢ. COS_ALLG(t₁, t₂) hence describes the cosine distance between the two expressions t₁ and t₂ in generalised form.

### b) Conditional Probability Model:

A conditional probability model is described subsequently, which can be applied to the different terms of the individual context and general context (occurrence context and content context according to the state of the art and also combination context according to the invention described subsequently in addition).

The idea behind this approach is that the strength of the relationship between two expressions depends upon how strongly one expression is conditional upon the other or, more generally expressed, how probably the individual context of an expression t₁ of a pair of expressions is conditional upon the general context (i.e. the occurrence of both expressions t₁ and t₂ of the pair). This can be determined via the conditional probability P(t₁|t₂), i.e. the probability that the expression t₁ occurs, under the condition of the expression t₂ (i.e. under the condition that the expression t₂ already occurs in the considered text segment). This conditional probability P(t₁|t₂) can be calculated as normal via the probability P(t₁, t₂) for the common context of t₁ and t₂, (i.e. the probability that t₁ and t₂ occur together in one text segment) and the probability P(t₂) for the context of t₂ with or without t₁ (i.e. that t₂ occurs within the considered text segment):

$$P ( {t}_{1} \vert {t}_{2} ) = \frac{P ( {t}_{1} , {t}_{2} )}{P ( {t}_{2} )}$$

In order to determine how greatly the two expressions of one pair of expressions (t₁, t₂) are mutually dependent, the conditional probabilities can then be multiplied together in both directions or with respect to each of the two expressions, as a result of which the common conditional probability is produced as follows:

$$P ( {t}_{1} \vert {t}_{2} ) * P ( {t}_{2} {t}_{1} ) \vert = \frac{{P ( {t}_{1} , {t}_{2} )}^{2}}{P ( {t}_{1} ) * P ( {t}_{2} )}$$

### c) Occurrence Context of the State of the Art:

The occurrence context is one of the context types most known to be used. The occurrence context of a (target) expression t is defined as the quantity (or the number) of text segments which contain the expression t (the content or the expressions which are otherwise still contained in the text segments are hereby not taken into account). As already described previously, for example an entire document or even a part of a document can be used as text segment. In the latter case, for example paragraphs, entire sentences or also text windows with a fixed window width (i.e. text sections which contain a precisely defined number of expressions) can be used as text segments. Large text segments (in particular entire documents) hereby represent comparatively non-specific contexts which cannot generally provide a reliable basis for decisions about relationships between expressions. Accordingly, it is advantageous rather to use small text segments.

Advantageously, two types of windows or text segments are hereby differentiated: windows for a target term or target expression t (subsequently also termed: text segment|tε text segment) and window for two target terms t₁, t₂ (subsequently also termed: text segment|t₁, t₂ε text segment). The unit of the distance or also the position of such a text window is then always a single expression which, as already defined above, can comprise one word or even several words.

In the present embodiment, text segments are used which comprise a defined number of expressions starting to the left and to the right with a target expression. The defined number is hereby set advantageously at approx. 20 so that, in total, at a value of precisely 20 expressions, a window width of 41 expressions is produced. In the above-described window for a target expression t, it applies hence that a window for a target expression t always relates to a position of the target expression t in a document and that the window of t in a specific position comprises n expressions to the left and n expressions to the right of this position (it should be taken into account hereby that the document limit is not exceeded on both sides or at both window ends).

The occurrence context for an expression t is now defined as follows:

occ(t)={Text segment|tεText segment}

occ(t) hence describes the quantity of all those text segments for which it applies that the expression t occurs in the respectively considered text segment (expressed more precisely, occ(t) describes the number of these text segments). The probability that an expression t occurs in one text segment can hence be estimated from the relative number of such text segments:

$$P ( t ) = \frac{\vert occ ( t ) \vert}{N}$$

N hereby describes the number of all text segments in the text collection. |occ(t)| describes for the quantity occ(t) its cardinal number or cardinality, i.e. the number of elements of the quantity. Subsequently, for this number or the cardinal number, both the expression |occ(t)| and, simplified, the expression occ(t) is used (this applies also to the other cardinals, such as e.g. |occ_con(t₁, t₂)|). There is thereby produced from the respective sense context whether, with e.g. occ(t), the quantity itself is intended or in simplified notation the cardinal number thereof.

The common context of two expressions t₁ and t₂ can be defined correspondingly as the quantity (more precisely expressed the number) of those text segments in which t₁ and t₂ both occur together:

occ(t₁,t₂)={Text segment|t₁,t₂εText segment}

The window used hereby for the two target expressions t₁ and t₂ always relates to the positions of both target terms pos(t₁) and pos(t₂), the distance of the two target terms being at most n terms or expressions, i.e. there applies: |pos(t₁)−pos(t₂)|≦n. If hence without restricting the generality, the assumption pos(t₂)>pos (t₁) applies, then a window for the two terms t₁ and t₂ extends by n expressions to the left from pos (t₂) and by n terms to the right from pos (t₁).

Both previously described types of windows (window for a target term and window for two target terms) are dynamic or can be displaced in a sliding manner over a document and can also hereby overlap.

Again the probability that both expressions t₁ and t₂ occur together within one text segment or within a common context (this is described subsequently also abbreviated as “t₁ with t₂”) can be estimated from the relative number of common text segments.

$$P ( {t}_{1} with {t}_{2} ) = \frac{\vert occ ( {t}_{1} , {t}_{2} ) \vert}{N}$$

The common conditional probability (i.e. the probability that the two expressions are mutually dependent) is then produced via

$$P ( {t}_{1} \vert {t}_{2} ) * ( P ( {t}_{2} \vert {t}_{1} ) = \frac{{\vert occ ( {t}_{1} , {t}_{2} ) \vert}^{2}}{\vert occ ( {t}_{1} ) * \vert occ ( {t}_{2} ) \vert}$$

| . . . | thereby again describes the cardinal number of the corresponding quantity.

Corresponding to the previously mentioned cosine weighting, a similarity weighting based purely on the occurrence frequency can be obtained herefrom as follows:

$$rel\_occ ( {t}_{1} , {t}_{2} ) = \frac{\vert occ ( {t}_{1} , {t}_{2} ) \vert}{\sqrt{\vert occ ( {t}_{1} ) * \vert occ ( {t}_{2} ) \vert}} \qquad F3 )$$

### d) Content Context According to the State of the Art:

The main disadvantage of the occurrence-based approaches, as were described in section c), is that they do not take into account the content (i.e. the expressions occurring together with the examined expressions t₁ and t₂ within the text segments). This leads above all to the problem that a multiple common occurrence of the examined expressions t₁ and t₂ in the same content context (e.g. two identical sentences in which t₁ and t₂ respectively occur) wrongly increases the similarity weighting of the pair (t₁, t₂) too greatly. One approach for avoiding this is jointly to include in the consideration the expressions occurring actually in the context together with t₁ and/or t₂.

This is effected by means of the following definition of the content context:

con(t)={expressions t_{con}|t_{con} with t}

“t_{con} with t” hereby means that the expression t_{con} occurs together with the expression t in the same text segment. con(t) hence describes the quantity of all those expressions t_{con} (more precisely: the number thereof) which occur in the quantity of considered text segments respectively together with t within one text segment.

The common content context of two expressions t₁ and t₂ can accordingly be defined by means of the intersection of the two (individual) contexts of the terms t₁ and t₂:

$$\begin{matrix}con ( {t}_{1} , {t}_{2} ) = con ( {t}_{1} ) ⋂ con ( {t}_{2} ) \\ = \{ expressions {t}_{con} \vert {t}_{con} with {t}_{1} , {t}_{con} with t 2 \}\end{matrix}$$

The two above definitions of the individual content context and of the common content context can be used again in order to define a common conditional probability:

$$P ( {t}_{1} with {t}_{con} \vert {t}_{2} with {t}_{con} ) * P ( {t}_{2} with {t}_{con} \vert {t}_{1} with {t}_{con} \} = \frac{{\vert con ( {t}_{1} , {t}_{2} ) \vert}^{2}}{\vert con ( {t}_{1} ) \vert * \vert con ( {t}_{2} ) \vert}$$

If in this definition the content of a context is jointly taken into account, then relationships or similarities between terms t₁ and t₂ can also be established if the two terms t₁ and t₂ of the pair do not occur together within one text segment but occur respectively individually together with the same context expressions. Hence for example a relationship or a similarity between the expressions t₁=“cat” and t₂=“dog” can be derived if, in the quantity of considered text segments, a text segment “a cat runs down a hill” and a text segment “a dog runs down a hill” occur even if the expressions “cat” and “dog” do not occur together within one text segment. It is shown that the pure content-based approaches, as are described in the present section d), in particular in the field of automatic thesaurus construction, operate comparatively poorly. This is due presumably to the fact that generic terms (i.e. terms which have a comparatively broad scope with regard to the content) occur together with a large number of expressions t_{con} within the examined text segments, the terms t_{con} then not being able however to indicate any specific aspects of such generic terms: if t₁ and t₂ are such generic terms, then also a large number of t_{con} expressions are provided which occur at least once together with the first generic term t₁ within one text segment and also at least once together with the second generic term t₂ within a further text segment, i.e. are detected from con(t₁, t₂) or the corresponding intersection. In this case, no meaningful relationship with respect to content is however derived from con(t₁, t₂). In the above-mentioned example, a text segment “a boy runs down a hill” would likewise lead to a relationship between “dog” and “boy” (or also to a relationship or similarity between “cat” and “boy”) even if the semantic similarity of this pair of terms is certainly only very low. The problem here is hence that the content expression t_{con} “runs down a hill” occurs in conjunction with a large number of moving objects and accordingly does not describe a significant common aspect between “boy” and “cat” (or between “boy” and “dog”).

### Similarity Weighting According to the Invention

In order to resolve the above-described problems of the state of the art, it is proposed according to the invention to combine the occurrence context and the content context in one term of a common context which is based on the common occurrence and the common content, i.e. forming a similarity measure occ_con(t₁, t₂) which takes into account both the total frequency of the common occurrence of both expressions t₁ and t₂ of the pair of expressions within text segments and the total number of different context expressions in this quantity of text segments. A context expression is hereby an expression which occurs in the quantity of text segments in at least one text segment together with the expressions t₁ and in at least one further text segment of this quantity together with the expression t₂, but neither t₁ nor t₂ thereby correspond (i.e. is identical neither to t₁ nor to t₂).

Such a similarity measure is particularly advantageous according to the invention, as calculated in the following:

occ_{—}con(t₁, t₂)={expressions t_{con}|t_{con} with t₁, t_{con} with t₂, t_{con} with (t₁ and t₂)}

The thus defined similarity measure occ_con(t₁, t₂) (or in the alternative cardinal number notation: |occ_con (t₁, t₂)|) hence corresponds to the quantity of all those context expressions t_{con} (more precisely: the number thereof, for which it applies that they occur together with t₁ and t₂ in one and the same text segment. Regarded from the point of view of content, the presented advantageous similarity measure occ_con(t₁, t₂) according to the invention describes a content context which takes into account the content of the text segments in which t₁ and t₂ occur together, whilst, regarded from the point of view of occurrence, the presented dimension figure requires that the two examined expressions t₁ and t₂ also occur respectively together in one and the same text segment. Compared with the previously described pure occurrence-based common context, this advantageous similarity measure according to the invention based on occurrence and content hence endows all the different context expressions t_{con}, which occur together with t₁ and t₂ in the same text segment, with the same importance irrespective of how frequently such a common occurrence of t₁ and t₂ actually occurs with a specific t_{con}. Hence a multiple common occurrence of the expressions t₁ and t₂ together in identical content surroundings does not affect the similarity measure occ_con(t₁,t₂) (and hence also the similarity weightings agw(t₁, t₂) according to the invention calculated therefrom, see later). In comparison with the previously described pure content-based common contexts, the advantageous similarity measure according to the invention merely takes into account those context expressions t_{con} which occur together with t₁ and t₂ within one text segment; hence the significance of the common aspect of the two expressions t₁ and t₂, i.e. the actual presence of a semantic similarity, is better detected by this similarity measure.

The advantageous term of the common context, used in the present embodiment (i.e. the previously described similarity measure occ_con(t₁,t₂)) can now be used as described in the following in order to calculate two types of conditional probabilities (these conditional probabilities can then be used either directly themselves or as a combination in order to calculate similarity weight values agw(t₁, t₂) according to the invention for pairs of expressions):
a) a first conditional probability which normalises the above-described similarity measure occ_con(t₁, t₂) with the help of the occurrence context and
b) a second conditional probability which normalises the similarity measure occ_con(t₁, t₂) with the help of the common content context.

### a) First Conditional Probability:

This measures how frequently the presence of the first expression t₁ in a text segment has the result that the second expression t₂ occurs together with a common context expression t_{con} in the same text segment and vice versa.

$$P ( {t}_{1} with {t}_{con} , {t}_{2} with {t}_{con} \vert {t}_{1} ) * P ( {t}_{1} with {t}_{con} , {t}_{2} with {t}_{con} \vert {t}_{2} ) = \frac{{\vert occ\_con ( {t}_{1} , {t}_{2} ) \vert}^{2}}{\vert occ ( {t}_{1} ) \vert * \vert occ ( {t}_{2 )} ) \vert}$$

This common conditional probability hence takes into account the above-described problem of the multiple common occurrence of t₁ and t₂ within identical (or similar) content contexts. For better comparability with the cosine similarity weighting COS known from the state of the art, a first similarity weight value agw(t₁, t₂) according to the invention can be hence obtained directly as follows (see the preceding section c) for the state of the art for the definition of occ(tᵢ)):

$$rel\_occ \_con ( {t}_{1} , {t}_{2} ) = \frac{\vert occ\_con ( {t}_{1} , {t}_{2} ) \vert}{\sqrt{\vert occ ( {t}_{1} ) \vert * \vert occ ( {t}_{2} ) \vert}} \qquad F1 )$$

### b) Second Conditional Probability:

This detects the probability that two expressions t₁ and t₂ occur together in common if the condition is fulfilled that both of them occur separately with a common context term t_{con} (i.e. that t₁ occurs with t_{con} in a first text segment) and t₂ occurs with t_{con} in a second text segment. The second conditional probability is defined by

$$P ( {t}_{1} with {t}_{2} \vert {t}_{con} with {t}_{1} , {t}_{con} with {t}_{2} ) = \frac{\vert occ\_con ( {t}_{1} , {t}_{2} ) \vert}{\vert con ( {t}_{1} , {t}_{2} ) \vert} \qquad F2 )$$

and can be used directly in this form as similarity weight value agw(t₁, t₂) according to the invention (definition of the value con(t₁, t₂), see preceding section d) for the state of the art). The thus calculated similarity weight value agw(t₁, t₂) is also termed aspect_ratio(t₁, t₂).

The conditional probability calculated thus according to F2) takes into account the problem of those common context expressions t_{con} which are detected by the dimension figure con(t₁, t₂) but not by the dimension figure occ_con(t₁, t₂). A thus calculated similarity weight value (aspect ratio) achieves that ostensible relationships between generic terms (such as for example “moon” or “star”) which have a tendency to have many common context expressions (which leads to the fact that con(t₁, t₂) becomes large) are eliminated. It is hereby advantageous that the aspect_ratio eliminates no actually present relationship between a generic term and an associated very specific term (such as for example “telescope” and “Ritchey-Chretien telescope”). The latter can be attributed to the fact that the common content context of a specific expression with any other expression is usually relatively low.

For normalisation of the similarity measure occ_con(t₁, t₂): as already described, occ_con is an occurrence context from one perspective—the total frequency of the common occurrence of the two expressions t₁ and t₂ being take into account; from the other perspective, a content context—the total number of different context expressions being taken into account. From the different perspectives, occ_con(t₁, t₂) can therefore be normalised differently:
1. From the perspective of the occurrence context, occ_con is normalised by the individual occurrence contexts, i.e. occ(t₁) and occ(t₂):

$$\frac{\vert occ\_con ( {t}_{1} , {t}_{2} ) \vert}{\sqrt{\vert occ ( {t}_{1} ) \vert \times \vert occ ( {t}_{2} ) \vert}}$$

2. From the perspective of the content context there are basically two further normalisation possibilities:
2.1. occ_con is normalised by the individual content contexts, i.e. con(t₁) and con(t₂):

$$\frac{\vert occ\_con ( {t}_{1} , {t}_{2} ) \vert}{\sqrt{\vert con ( {t}_{1} ) \vert \times \vert con ( {t}_{2} ) \vert}}$$

2.2. occ_con is normalised by the common content contexts of t₁ and t₂, i.e. by con(t₁, t₂), in this case the aspect ratio is produced:

$$\frac{\vert occ\_con ( {t}_{1} , {t}_{2} ) \vert}{\vert con ( {t}_{1} , {t}_{2} ) \vert}$$

As was detected in experiments, 1. and 2.1. behave very similarly for the relation calculation, 1. intersecting slightly better than 2.1. A large problem of the occurrence context occ resides in the fact that the relation between t₁ and t₂ is wrongly estimated too greatly in the case of a multiple common occurrence of t₁ and t₂ in the same or similar content surroundings. In this case, the values of |occ(t₁)| and |occ (t₂)| can be relatively large because the frequency of the common occurrence is relatively large and the values of |occ_con(t₁, t₂)|, |con(t₁)|, |con(t₂)| are relatively small because the content surroundings are similar. The latter three quantities or cardinals therefore contain only a few different context expressions. Thus 2.1 with a small numerator and small denominator could lead to a relatively large ratio number, which is wrong. In contrast thereto, the ratio number in 1. with a small numerator and a large denominator will always be small, which is correct. 2.2. in fact always has the same problem as 2.1. but it uses other correlations for relation calculation than 1. and 2.1., as described previously. Therefore, 1. and 2.2. was used or combined in the present invention.

From the previous presentations, the following similarity weight values are hence produced:
F1) rel_occ_con(t₁, t₂)
F2) aspect_ratio(t₁, t₂)
F3) rel_occ(t₁, t₂)

Each of these similarity weight values is based on different statistical approaches or uses different statistical proofs in order to indicate the existence of semantic relationships between the terms t₁ and t₂.

According to the invention, it is now proposed firstly to implement the quantification of the similarity of the two expressions t₁ and t₂ with the help of the similarity weight value F1 or the similarity weight value F2. However it is more advantageous according to the invention to use one of the following product combinations as similarity weight value agw(t₁, t₂): F1*F2, F1*F3 or F2*F3. It is however particularly advantageous according to the invention to use the product combination F1*F2*F3 from all three presented similarity weight values, i.e.

rel_{—}comb(t₁,t₂)=aspect_ratio(t₁, t₂)*rel_{—}occ_{—}con(t₁, t₂)*rel_{—}occ(t₁, t₂)

The advantages of this triple product combination rel_comb(t₁, t₂) are produced in particular in that, for each of its individual indicators for the existence of a semantic relationship between the terms t₁ and t₂, different statistical information are taken into account for the relationship determination.

Comparison of the Similarity Quantification According to the Invention with Similarity Quantifications According to the State of the Art

A similarity calculation system according to the invention, the essential components of which were already indicated above (and which is described more precisely with respect to its individual components subsequently with reference to FIG. 4) advantageously has a target expression pair selection unit with which, based on calculated similarity weight values agw(tᵢ₁, tᵢ₂), a definable number m (m ε of natural numbers with m≧2) of candidate expression pairs (tᵢ₁, tᵢ₂) with i=1, . . . m can be selected. The selection hereby takes place preferably such that those m candidate expression pairs are selected which have the largest calculated similarity weight values. These m-selected candidate expression pairs are subsequently also termed target expression pairs.

By means of such a selected quantity of m target expression pairs, evaluation of the similarity weighting according to the invention can be effected.

For this purpose, firstly for different similarity weight methods to be compared respectively for each method, similarity weight values for each possible pair of candidate expressions are calculated. The selection of m target expression pairs can then be regarded as setting a threshold value which eliminates those candidate expression pairs, the similarity weight value of which is below a specific dimension value.

Since no similarity weighting method is perfect, the quantity of m target expressions will unavoidably contain noise, i.e. pairs of expressions for which in reality there is no relationship but which were provided wrongly with a high similarity weight value. The principle of the subsequently described evaluation is based on the fact that a good similarity weighting method will provide semantic relationships which actually exist or are of interest with a higher similarity weight value than a poor method so that, within the m selected target expression pairs, more pairs with actually occurring semantic relationships (subsequently also termed “relationships of interest”) occur than in the case of a poor similarity weighting method.

Whether there is actually a relationship of interest between a specific expression pair (tᵢ₁, tᵢ₂) is evaluated by automatic comparison with a manually produced thesaurus for the considered document collection: a target expression pair relationship has been classified then correctly as of interest by a considered method if it has been defined as a relationship of interest within the manually produced thesaurus (gold standard).

The efficacy of a similarity weighting method can be evaluated in that its precision PR(m) and its target quota R(m) is calculated as a function of the number m of selected target expression pairs with reference to the given gold standard. If L is the total number of pair-wise relationships defined as present in the gold standard, i.e. the total number of relationships of interest, m is the number of target expression pairs selected by the method with reference to the similarity weight values (only weight values from the documents are hereby calculated for such pairs, both expressions of which are also present in the gold standard) and, if y(m) is the number of those target expression pairs selected amongst the m which have a relationship of interest in the sense of the gold standard, then the precision and the target quota can be defined as follows;

PR(m)=y(m)/m

R(m)=y(m)/L

With the help of the F measure (cf. Van Rijsbergen: “Information Retrieval”, 1979), these two measuring values can be recorded combined in a single measuring value:

$$F = \frac{2 * PR * R}{PR + R}$$

If now for each selected number m of target expression pairs the associated F measure F(m) is plotted on the ordinate, then different similarity weightings can be compared with reference to their different F(m) curves. A similarity weighting method, the F(m) curve of which for a specific value of m is above the F(m) curve of another similarity weighting method, is hence the better method with reference to this m value.

The subsequently represented comparative results were obtained as follows:
Use of approx. 8000 text documents from the field of astronomy as text collection. The text documents were pre-processed as already described above.
A manually produced astronomy thesaurus which contains approx. 2900 individual terms was used as gold standard.
Instead of selecting a quantity of candidate expressions tᵢ, as is normal in automatic thesaurus construction, in a first step by means of a suitable expression selection method (as is described for example in reference 1) by means of allocation of suitable weight values for each expression, for which candidate expressions the similarity weight values agw(t₁, t₂) are then calculated in pairs, those pairs of gold standard expressions were determined in a simple manner for which both expressions t₁ and t₂ of one pair respectively occur together in at least three documents of the text collection. This produced approx. 40,000 candidate expression pairs. A relationship of interest (L=743) is allocated to 743 of these candidate expression pairs in the gold standard thesaurus. The object of the similarity weighting method to be compared can hence be described by how many of the m selected, highest-weighted target expression pairs (tᵢ₁, tᵢ₂) belong to those y pairs to which a relationship of interest is allocated in the gold standard (m can hence be varied in the range of 1 to 40,000). Results of the different similarity weighting methods for the extraction of gold standard relationships of interest are reproduced subsequently in sections.

FIG. 2 now shows the results for different types of methods of the PMI similarity weighting method known from the state of the art. The different types differ in their type of calculation for the individual frequencies f. Thus for example in the type of method represented in the first line of FIG. 2A, the frequency f_{t1, t2} was calculated with the help of the similarity measure occ_con(t₁, t₂) according to the invention, whilst the frequency for the individual context of the terms t₁ or t₂ was calculated with the help of the above-described occ(tᵢ) measure (i=1, 2). In the case of the type of method represented in the second line, in contrast hereto, the common context was calculated for example with the help of the occ(t₁, t₂) dimension figure of the state of the art (the individual contexts were calculated as in the type of method represented in the first line). The size of the text segments in the types of method described in the first three lines of FIG. 2A was set to 41 (20 expressions to the left and to the right of the respectively central target expression).

In contrast, a type of method was chosen merely in the fourth line (PMI_occ_doc) in which the corresponding frequency dimension figures occ(t₁) or occ(t₁, t₂) were calculated on the basis of text segments in the form of complete text documents (the dimension figures or the value thereof are therefore termed occ_doc(tᵢ) or occ_doc(t₁, t₂)). FIG. 2B now shows the behaviour of the different types of methods represented in FIG. 2A of the PMI similarity weighting known from the state of the art. The different types of methods hereby differ as described above by the respectively used terms of the individual context and of the common context.

As FIG. 2B shows, that type of method which was calculated on the basis of text segments in the form of complete text documents shows the smallest F measure and hence represents the poorest of the four shown similarity weighting methods. As expected, those types of methods which are based on using smaller text segments show better results. However the type of method PMI_con which is based on the content context intersects only slightly better. The purely occurrence context-based type of method PMI_occ already intersects significantly better than the purely content context-based type of method PMI_con. At best, if however that type of method of PMI similarity weighting intersects even with a relatively small projection, the common context of which similarity weighting was calculated on the basis of the similarity measure occ_con(t₁, t₂) according to the invention: PMI_occ_con. The presented example hence shows that already by including the similarity measure occ_con(t₁, t₂) according to the invention in similarity weightings which are known already from the state of the art such as the PMI similarity weighting, better results can be achieved than when using a common context which is purely content-based or purely occurrence-based.

As FIG. 3 shows, the complete advantages of the similarity measure occ_con(t₁, t₂) according to the invention are however only used when the latter is used also in the previously described similarity weightings according to the invention. FIG. 3 compares these similarity weightings with the purely occurrence-based cosine similarity weighting COS_occ_doc_ALLG which is used frequently in the state of the art and which is based on text segments in the form of whole text documents (the COS measure having been calculated however as described previously according to the generalised dimension figure COS_ALLG). For comparison, the purely occurrence-based similarity weighting F3, i.e. rel_occ(t₁, t₂), is further illustrated (see previously). As is only to be expected, the document-based similarity weighting COS occ_doc_ALLG intersects worst here with a clear spacing. The similarity weightings rel_occ_con(t₁, t₂) or aspect-ratio(t₁, t₂) according to the invention which are based on merely one partial factor F1 or F2 already intersect significantly better. Even the similarity weighting rel_occ(t₁, t₂) which is based purely on the occurrence frequency intersects here comparatively well. Since however each of the three individual factors F1, F2 or F3 (see previously) is based on different proofs for the presence of a relationship, the capacity of the similarity weighting agw(t₁, t₂) according to the invention is all the better relative to identification of the actually relevant relationships the more the individual factors go into the similarity weighting as product combination. Thus the binary product combinations F2*F3 or F1*F3 (aspect_ratio*rel_occ or rel_occ_con*rel_occ) already show once again a clearly improved F measure (the third binary combination F1*F2 or rel_occ_con*aspect_ratio is not illustrated here since the results are situated very near to the other two binary combinations.) The unequivocally best results are shown however by the similarity weighting rel_comb(t₁, t₂) according to the invention which is calculated on the basis of the product combination of all three individual factors F1, F2 and F3:

rel_{—}comb(t₁, t₂)=aspect_ratio(t₁,t₂)*rel_{—}occ_{—}con(t₁,t₂)*rel_{—}occ(t₁, t₂)

The maximum F measure here is 0.2407, which, in comparison with the similarity weighting COS_occ_doc_ALLG (F-max 0.1424) corresponds to an improvement of approx. 70%. COS_occ_doc_ALLG was therefore used here also as comparative similarity weighting for the reason that this calculation method in the field of automatic thesaurus construction at present represents the most frequently applied method.

FIG. 4 shows finally the concrete construction of an automatic, computer-based similarity calculation system according to the invention. In the present case, the system is configured by means of a computer system in the form of a personal computer PC (R). The system firstly comprises a document memory unit or document data bank unit (1). This serves to store text documents in electronic form. The memory unit (1) is connected on the input side to an adaptor unit (10) in the form of a CD/DVD reader. In the present case, the collection of text documents to be stored in the document data bank unit (1) can be stored firstly as a text document collection (1a) on an optical disc CD (9). The individual text documents can then be read by means of the adaptor (10) from the optical disc and can be stored in the document data bank unit (1).

On the output side, the document data bank unit (1) is connected to a text document pre-processing unit (5). In the latter, the individual text documents can be pre-processed as described previously; here for example control words, such as html control commands or also stop words, can be eliminated from the individual text documents. Likewise, a root reduction is possible. The text document pre-processing unit (5) here has a memory in which the pre-processed text documents can be stored. From the pre-processed text documents, a quantity of individual expressions which are characteristic of the document collection under consideration, the candidate expressions tᵢ, can then be selected with the candidate expression selection unit (4). How the selection of such candidate expressions from the text documents can take place is known from the state of the art and is therefore not described here in more detail. It may merely be indicated as an example that the category-specific expressions for a specific text category (for example text documents which are involved with respect to content with the thematic field of astronomy) are selected with the help of a variance analysis, as is described for example in reference 1. The quantity of selected candidate expressions tᵢ can then be stored in the candidate expression memory unit (2) which is connected to the candidate expression selection unit (4).

The core of the shown similarity calculation system is the similarity weight value calculation unit (3) which is connected on the input side both to the document pre-processing unit (5) and to the candidate expression memory unit (2). The similarity weight value calculation unit (3) selects pairs of candidate expressions (t₁, t₂) from the memory unit (2), examines, as described already in detail, the occurrence of the individual expressions of a pair or both expressions of a pair in text segments of the text documents stored in the unit (5) and performs all the further necessary steps, as were described previously, for the calculation according to the invention of the similarity weight values agw(t₁, t₂) of the pairs. The calculation unit (3) likewise has a memory unit in which the calculated similarity weight values agw can be stored.

On the output side, the similarity weight value calculation unit (3) is connected to a target expression pair selection unit (6). This can select a defined number m (i=1, . . . m) of candidate expression pairs (tᵢ₁, tᵢ₂) based on similarity weight values agw(tᵢ₁, tᵢ₂) which are already calculated by the calculation unit (3). Preferably, the target expression pair selection unit (6) operates such that, from the quantity of candidate expression pairs for which weight values were calculated, those m candidate expression pairs are selected which have the highest calculated similarity weight values agw(tᵢ₁, tᵢ₂) (i=1, . . . m). The target expression pair selection unit (6) can be produced as a hardware circuit or also be stored as corresponding programme code within a memory unit. The same also applies to the described pre-processing unit (5) and the described candidate expression selection unit (4) and also to the structuring unit (8) which is described subsequently also. Production which occurs in part in the form of a hardware circuit and in part in the form of a programme code is also possible. In order that the m candidate expression pairs with the highest similarity weight values can be selected, the target expression pair selection unit (6) here has a target expression pair sorting unit (7), with which candidate expression pairs can be sorted according to their weight values.

On the output side, the selection unit (6) is connected to a target expression pair structuring unit (8). With the latter, the individual expressions of the m selected target expression pairs based on the m associated similarity weight values of the target expression pairs can be disposed in a hierarchical structure by means of a suitable method. Also such structuring units or corresponding structuring methods are known from the state of the art, as a result of which they will not be dealt with here any further. For example a hierarchical structuring by means of the layer-seed method from reference 1 is hereby possible.

The hierarchical structure determined in the structuring unit (8) or also the m selected target expression pairs can be then be displayed on the monitor (11).

1. An automatic, computer-based similarity calculation system for the calculation of similarity weight values for pairs of expressions, a similarity weight value quantifying the similarity of the two expressions of a pair of expressions, the system having a document data bank unit, in which or on which a collection of text documents which comprises at least one text document is at least one of storable and is stored in digital form, a candidate expression memory unit, in which a quantity of candidate expressions tᵢ which comprises several expressions is at least one of storable and stored, each expression tᵢ occurring in at least one of the text documents of the collection, and a similarity weight value calculation unit, with which at least one pair of candidate expressions t₁ and t₂ is selectable from the quantity of candidate expressions and with which a similarity weight value agw(t₁, t₂) is calculable for the at least one selected pair of expressions, wherein the similarity weight value agw(t₁, t₂) is calculable on the basis of a similarity measure |occ_con(t₁, t₂)| which takes into account both the total frequency of the common occurrence of the two expressions t₁ and t₂ of the pair of expressions within one and the same text segment in a quantity of several text segments which is selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

2. The similarity calculation system according to claim 1 wherein context expressions are only those expressions which occur in the quantity of text segments in at least one text segment together with both expressions t₁ and t₂.

3. The similarity calculation system according to claim 1 wherein the similarity measure occ_con(t₁, t₂) is the total number of all those context expressions which occur in the quantity of text segments in at least one text segment together both with the expression t₁ and with the expression t₂ and which correspond or are equal neither to t₁ nor t₂, a context expression which occurs in identical form in more than one of the text segments being counted only once so that only the number of different context expressions is taken into account.

4. The similarity calculation system according to claim 1 wherein the similarity weight value agw(t₁, t₂) is calculable on the basis of at least one conditional probability for the occurrence of a second expression or several second expressions within one text segment under the condition of the occurrence of a first expression or several first expressions within this text segment or on the basis of an approximation of such a conditional probability.

5. The similarity calculation system according to claim 4 wherein the conditional probability is the product of one of two conditional probabilities and approximations of two conditional probabilities.

6. The similarity calculation system according to claim 5 wherein one of the two conditional probabilities has the occurrence of t₁ within one text segment as a given condition and in that the other conditional probability has the occurrence of t₂ within one text segment as a given condition.

7. The similarity calculation system according to claim 3 wherein the similarity weight value agw(t₁, t₂) is calculable on the basis of the normalized similarity measure occ_con(t₁, t₂), the normalization of occ_con(t₁, t₂) being effected by means of the product of the total number of text segments in the quantity of text segments in which t₁ occurs and the total number of text segments in the quantity of text segments in which t₂ occurs.

8. The similarity calculation system according to claim 3 wherein the similarity weight value agw(t₁, t₂) is calculable according to one of the two following formula expressions:
rel_{—}occ_{—}con(t₁, t₂)=|occ_{—}con(t₁, t₂)|/sqrt(|occ(t₁)|×|occ(t₂)|), F1)

|occ(tᵢ)| with i=1, 2 being the total number of text segments in the quantity of text segments in which tᵢ occurs and
aspect_ratio(t₁, t₂)=|occ_{—}con(t₁, t₂)|/|con(t₁, t₂)| F2)

|con(t₁, t₂) being the total number of those different context expressions which occur in the quantity of text segments in at least one text segment together with the expression t₁ and in at least one text segment together with the expression t₂ and correspond neither to t₁ nor t₂.

9. The similarity calculation system according to claim 8 wherein the similarity weight value agw(t₁, t₂) is calculable as the product of the formula expression F1 and of the formula expression F2 from the preceding claim:
agw(t₁, t₂)=[|occ_{—}con(t₁, t₂)|/sqrt(|occ(t₁)|×|occ(t₂)|)]×[|occ_{—}con(t₁, t₂)|/|con(t₁, t₂)|].

10. The similarity calculation system according to claim 8 wherein the similarity weight value agw(t₁, t₂) is calculable as the product of one of the formula expressions F1 and F2 and the formula expression rel_occ(t₁, t₂) with
rel_{—}occ(t₁, t₂)=|occ(t₁, t₂)|/sqrt(|occ(t₁)|×|occ(t₂)|) F3)

|occ(tᵢ)| with i=1, 2 being the total number of text segments in the quantity of text segments in which tᵢ occurs and |occ(t₁, t₂)| being the total number of text segments in the quantity of text segments in which t₁ and t₂ occur together.

11. The similarity calculation system according to claim 10 wherein the similarity weight value agw(t₁, t₂) is calculable as the product of the formula expressions F1, F2 and F3 in that there therefore applies:
agw(t₁, t₂)=rel_{—}comb(t₁, t₂)=|occ_{—}cont(t₁, t₂)|/sqrt(|occ(t₁)|×|occ(t₂)|)×|occ_{—}con(t₁, t₂) |/|con(t₁, t₂)|×|occ(t₁, t₂)|/sqrt(|occ(t₁)|×|occ(t₂)|).

12. The similarity calculation system according to claim 1 wherein at least one of the text segments from the quantity of text segments is a complete text document.

13. The similarity calculation system according to claim 1 wherein at least one of the text segments from the quantity of text segments is a part of a text document.

14. The similarity calculation system according to claim 13 wherein the part is one of: a chapter; a sub-chapter; a text paragraph; a sentence; a part of a sentence between two punctuation marks; and a part that corresponds to an established number n of individual expressions or words of the text document which are separated by blanks and are in succession (text window with window width n).

15. The similarity calculation system according to claim 14 wherein 3≦n≦101 preferably 11≦n≦81, preferably 21≦n≦61, preferably 31≦n≦51, particularly preferred n=41 applies.

16. The similarity calculation system according to claim 14 wherein at least two of the text segments from the quantity of text segments have at least one common segment section.

17. The similarity calculation system according to claim 1 further including a candidate expression selection unit with which candidate expressions tᵢ are selectable from the text document or documents of the collection and are transmittable to the candidate expression memory unit.

18. The similarity calculation system according to claim 17 further including a text document pre-processing unit with which the text documents of the collection can be pre-processed before the selection of the candidate expressions tᵢ and their transmission to the candidate expression memory unit.

19. The similarity calculation system according to claim 18 wherein the text document pre-processing unit has at least one of: a control word elimination unit with which text documents can be reduced by control words contained in them, and a stop word elimination unit with which text documents are reducible from stop words contained in them, and a root reduction unit with which words contained in text documents can be reduced to their respective roots and hence text documents can be reduced to collections of roots.

20. The similarity calculation system according to claim 1 further including a target expression pair selection unit with which, based on calculated similarity weight values agw(tᵢ₁, tᵢ₂), a definable number m (i=1, . . . m, m an element of the natural numbers and m≧2) of candidate expression pairs tᵢ₁ and tᵢ₂ can be selected.

21. The similarity calculation system according to claim 20 wherein the target expression pair selection unit has a target expression pair sorting unit with which candidate expression pairs can be sorted according to the size of their respective similarity weight value in an increasing or decreasing manner, and wherein, with the target expression pair selection unit, those m candidate expression pairs with the highest calculated similarity weight values are selectable.

22. The similarity calculation system according to claim 20 including a target expression pair structuring unit with which the individual expressions of the m selected target expression pairs are disposable in a hierarchical structure based on the m similarity weight values of the target expression pairs.

23. The similarity calculation system according to claim 1 wherein the occurrence of expressions in text segments are determinable without taking into account differences in case, the presence or absence of hyphens and differences in the number of blanks between individual successive words.

24. The similarity calculation system according to claim 1 including a computer system in which at least one of the document data bank unit, the candidate expression memory unit and the similarity weight value calculation unit are at least one of configurable and configured.

25. The similarity calculation system according to claim 24 wherein at least one of the document data bank unit, the candidate expression memory unit and the similarity weight calculation unit are at least one of configurable and configured at least partially by at least a part of the physical main memory of the computer system.

26. The similarity calculation system according to claim 1 including at least one memory device in which or on which the document data bank unit is at least partially configurable or configured.

27. The similarity calculation system according to claim 26 wherein the memory device comprises at least one of an optical disc and a portable hard disc.

28. The similarity calculation system according to claim 24 wherein the computer system has at least one data transfer device for transfer of text documents in digital form, with a memory device in which or on which the document data bank unit is at least partially configurable or configured.

29. A method for the calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within one and the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

30. (canceled)

31. The method according to claim 29 comprising taking into account as context expressions only those expressions which occur in the quantity of text segments in at least one text segment together with both expressions t₁ and t₂.

32. The method according to claim 29 including using as the similarity measure occ_con(t₁, t₂) the total number of all those context expressions which occur in the quantity of text segments in at least one text segment together both with the expression t₁ and with the expression t₂ and which correspond or are equal neither to t₁ nor t₂, and counting a context expression which occurs in identical form in more than one of the text segments only once so that only the number of different context expressions is taken into account.

33. The method according to claim 29 including calculating the similarity weight value agw(t₁, t₂) on the basis of at least one of a conditional probability for the occurrence of a second expression or several second expressions within one text segment under the condition of the occurrence of a first expression or several first expressions within this text segment and an approximation of such a conditional probability.

34. The method according to claim 33 wherein calculating the similarity weight value agw(t₁, t₂) on the basis of at least one of a conditional probability for the occurrence of a second expression or several second expressions within one text segment under the condition of the occurrence of a first expression or several first expressions within this text segment and an approximation of such a conditional probability comprises calculating the similarity weight value on the basis of the product of two conditional probabilities or of two approximations of the same.

35. The method according to claim 34 wherein one of the two conditional probabilities has the occurrence of t₁ within one text segment as a given condition and the other conditional probability has the occurrence of t₂ within one text segment as a given condition.

36. The method according to claim 32 including calculating the similarity weight value agw(t₁, t₂) on the basis of the normalized similarity measure occ_con(t₁, t₂), the normalization of occ_con(t₁, t₂) being effected by means of the product of the total number of text segments in the quantity of text segments in which t₁ occurs and the total number of text segments in the quantity of text segments in which t₂ occurs.

37. The method according to claim 32 comprising calculating the similarity weight value agw(t₁, t₂) according to one of the two following formula expressions:
rel_{—}occ_{—}con(t₁, t₂)=|occ_{—}con(t₁, t₂)|/sqrt(|occ(t₁)|×|occ(t₂)|), F1)

|occ(tᵢ) with i=1, 2 being the total number of text segments in the quantity of text segments in which tᵢ occurs; and
aspect_ratio(t₁, t₂)=|occ_{—}con(t₁, t₂)|/|con(t₁, t₂)|, F2)

|con(t₁, t₂)| being the total number of those different context expressions which occur in the quantity of text segments in at least one text segment together with the expression t₁ and in at least one text segment together with the expression t₂ and correspond neither to t₁ nor t₂.

38. The method according to claim 37 including calculating the similarity weight value agw(t₁, t₂) as the product of the formula expression F1 and of the formula expression F2:
agw(t₁, t₂)=[|occ_{—}con(t₁, t₂)|/sqrt(|occ(t₁)|×|occ(t₂)|)]×[|occ_{—}con(t₁, t₂) |/|con(t₁, t₂)|].

39. The method according to claim 37 including calculating the similarity weight value agw(t₁, t₂) as the product of one of the formula expressions F1 or F2 and from the formula expression rel_occ(t₁, t₂) with
rel_{—}occ(t₁, t₂)=|occ(t₁, t₂)|/sqrt(|occ(t₁)|×|occ(t₂)|) F3)

|occ(tᵢ)| with i=1, 2 being the total number of text segments in the quantity of text segments in which tᵢ occurs and |occ(t₁, t₂)| being the total number of text segments in the quantity of text segments in which t₁ and t₂ occur together.

40. The method according to claim 39 including calculating the similarity weight value agw(t₁, t₂) is calculated as the product of the formula expressions F1, F2 and F3, in that there therefore applies:
agw(t₁, t₂)=rel_{—}comb(t₁, t₂)=|occ_{—}cont(t₁, t₂)|/sqrt(|occ(t₁)|×|occ(t₂)|)×|occ_{—}con(t₁, t₂) |/|con(t₁, t₂)|×|occ(t₁, t₂)|/sqrt(|occ(t₁)|×|occ(t₂)|).

41. The method according to claim 29 wherein calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments comprises calculating the similarity weight value agw(t₁, t₂) on the basis of a similarity measure occ_con(t₁, t₂) which takes into account both the total frequency of the common occurrence of the two expressions t₁ and t₂ of the pair of expressions within at least one complete text document.

42. The method according to claim 29 wherein calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments comprises calculating the similarity weight value agw(t₁, t₂) on the basis of a similarity measure occ_con(t₁, t₂) which takes into account both the total frequency of the common occurrence of the two expressions t₁ and t₂ of the pair of expressions within at least one part of a text document.

43. The method according to claim 42 wherein calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments comprises calculating the similarity weight value agw(t₁, t₂) on the basis of a similarity measure occ_con(t₁, t₂) which takes into account both the total frequency of the common occurrence of the two expressions t₁ and t₂ of the pair of expressions within at least one part of a text document comprises calculating the similarity weight value agw(t₁, t₂) on the basis of a similarity measure occ_con(t₁, t₂) which takes into account both the total frequency of the common occurrence of the two expressions t₁ and t₂ of the pair of expressions within at least one of a chapter, a sub-chapter, a text paragraph, a sentence, a part of a sentence between two punctuation blanks and a part corresponding to an established number n of individual expressions or words of the text document which are separated by blanks and are in succession.

44. The method according to claim 43 wherein calculating the similarity weight value agw(t₁, t₂) on the basis of a similarity measure occ_con(t₁, t₂) which takes into account both the total frequency of the common occurrence of the two expressions t₁ and t₂ of the pair of expressions within at least one of a chapter, a sub-chapter, a text paragraph, a sentence, a part of a sentence between two punctuation blanks and a part corresponding to an established number n of individual expressions or words of the text document which are separated by blanks and are in succession comprises calculating the similarity weight value agw(t₁, t₂) on the basis of a similarity measure occ_con(t₁, t₂) which takes into account both the total frequency of the common occurrence of the two expressions t₁ and t₂ of the pair of expressions within at least one of a chapter, a sub-chapter, a text paragraph, a sentence, a part of a sentence between two punctuation blanks and a part corresponding to an established number n of individual expressions or words of the text document which are separated by blanks and are in succession where 3≦n≦101.

45. The method according to claim 43 wherein calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments comprises calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in at least two text segments having at least one common segment section.

46. The method according to claim 29 comprising determining the occurrence of expressions in text segments without taking into account at least one of differences in the case, the presence or absence of hyphens and differences in the number of blanks between individual successive words.

47. A method for at least one of automatic, computer-based selection of at least one of information, expressions of and terms from a quantity of text documents and structuring at least one of information, expressions and terms by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

48. A method for at least one of automatic, computer-based thesaurus construction and ontology construction by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

49. A method for at least one of construction of semantic relationships between terms of a thesaurus and terms of an ontology by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

50. A method for automatic, computer-based classification of text documents by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

51. A method for at least one of partially automatic, computer-based inquiry expansion, fully automatic, computer-based inquiry expansion, partially automatic, computer-based inquiry refinement, fully automatic computer-based inquiry refinement, partially automatic, computer-based interactive inquiry expansion, fully automatic, computer-based interactive inquiry expansion, partially automatic, computer-based interactive inquiry refinement, fully automatic, computer-based interactive inquiry refinement, internet search machine use and data bank search machine use by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

52. A method for automatic, computer-based construction of a semantic network for integration of different types of text document data banks by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

53. A method for at least one of automatic, computer-based construction of a short description for a subject area and automatic, computer-based construction of a summary of contents for a subject area by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.

54. A method for the automated construction of at least one of integration indices and search indices by calculation of similarity weight values for pairs of expressions, a similarity weight value quantifying the similarity of the two expressions of one pair of expressions, a collection of text documents which comprises at least one text document being stored in digital form, a quantity of candidate expressions tᵢ which comprises several expressions being stored, each expression tᵢ occurring in at least one of the text documents of the collection, and at least one pair of candidate expressions t₁ and t₂ being selected from the quantity of candidate expressions and a similarity weight value agw(t₁, t₂) being calculated for the at least one selected pair of expressions, the method comprising calculating the similarity weight value agw(t₁, t₂) on the basis of a similarity measure occ_con(t₁, t₂) which takes into account both the total frequency of the common occurrence of the two expressions t₁ and t₂ of the pair of expressions within the same text segment in a quantity of several text segments which are selectable or are selected from the collection of text documents and the total number of different context expressions in this quantity of text segments, a context expression being an expression which occurs in this quantity of text segments in at least one text segment together with the expression t₁ and in at least one text segment together with the expression t₂ and which corresponds neither to t₁ nor t₂.
